(19) United States
(12) Patent Application Publication
(10) Pub. No.: US 2008/0094500 A1
(43) Pub. Date: Apr. 24, 2008

(54) FRAME FILTER

(75) Inventors: Paul S. Everest, Corvallis, CO (US); Matthew J. West, Corvallis, CO (US); John G. Apostolopoulos, Corvallis, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/551,697

(22) Filed: Oct. 20, 2006

(51) Int. Cl. H04N 11/02; H04N 7/12; H04N 11/04

(52) U.S. Cl. 348/390.1; 348/387.1

(57) ABSTRACT

One or more streams of image frames are filtered and restored using filtering and restoration patterns, respectively.

### BACKGROUND

Signal transport mechanisms may have an insufficient bandwidth to transmit image frames at a desired rate. As a result, image quality is less than satisfactory.

### BRIEF DESCRIPTION OF THE DRAWINGS

FIG. 1 is a functional block diagram schematically illustrating a link according to an example embodiment.

FIG. 2 is a schematic illustration of a portion of the link of FIG. 1 schematically illustrating the filtering restoration of transmitted image frames according to an example embodiment.

FIG. 3 is a flow diagram illustrating a method for filtering and restoration of transmitted image frames according to an example embodiment.

FIG. 4 is a functional block diagram schematically illustrating another embodiment of the link of FIG. 1 according to an example embodiment.

### DETAILED DESCRIPTION OF THE EXAMPLE EMBODIMENTS

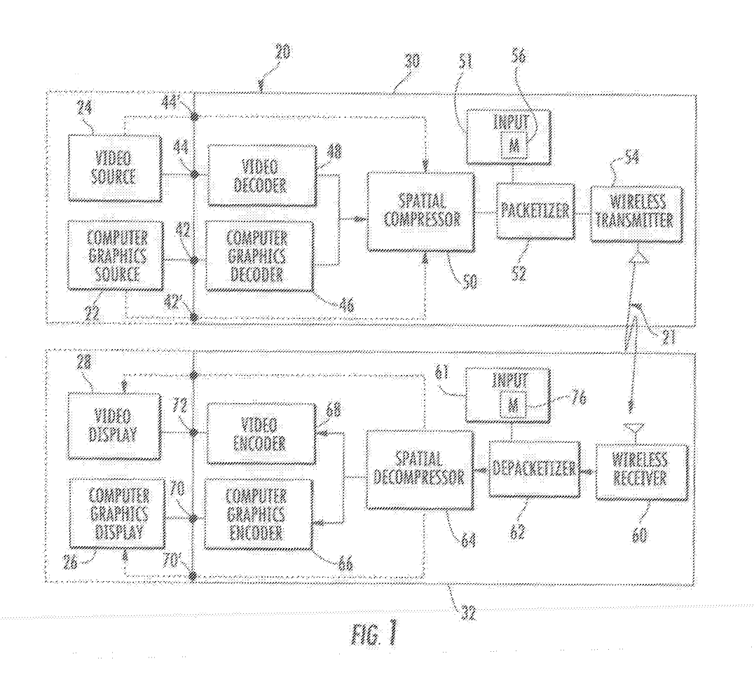

FIG. 1 is a functional block diagram schematically illustrating an image transmitting and receiving system or link 20. Link 20 is configured to transmit one or more streams of compressed image data across a distance from an image source 22, 24 to an image display 26, 28 in a manner so as to enhance the quality of the reconstructed image produced from the image data streams. For purposes of this disclosure, the term “image data” shall at least include, but not be limited to, computer graphics data such as provided by a computer graphics source 22 (for example, a desktop or laptop computer) and video graphics data, such as provided by a video graphics source 24 (for example, digital versatile disc (DVD) player, Blue-Ray disc player, other disc player or VCR). The transmitted computer graphics data is displayed on a computer graphics display 26 while the transmitted video graphics data is displayed on a video graphics display 28. Examples of a computer graphics display or a video graphics display, include, but are not limited to, a projection system or a flat-panel display. In the particular embodiment illustrated, link 20 is configured to transmit both computer graphics data and video graphics data. In other embodiments, link 20 may alternatively be configured to transmit one of either computer graphics data or video graphics data. In still other embodiment, link 20 may be configured to transmit other forms of image data.

In the example illustrated, link 20 is configured to transmit streams of compressed image data frames via transport mechanism 21 having an insufficient bandwidth or a limited bit rate capability that is less than the rate at which streams of image frames are provided from either of the image sources 22, 24. As will be described hereafter, link 20 includes components, devices or one or more processing units that analyze the compressed data stream to identify such frames, to selectively filter out image frames according to a filtering pattern prior to transmission across mechanism 21 and to replace filtered out frames with copies of received frames. As a result, link 20 enables compressed image frames to be transmitted via a bit rate limited transport mechanism and to be reconstructed into a high-quality image.

As shown by FIG. 1, link 20 generally includes transmitter module 30 and receiver module 32. Transmitter module 30 and receiver module 32 include one or more processing units by which computer graphics data or video data is manipulated before and after transmission. For purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, such processing units may be embodied as part of one or more application-specific integrated circuits (ASICs). Unless other wise specifically noted, the functional blocks of module 30 or module 32 are not limited to any specific combination of hardware circuitry, firmware or software, nor to any particular source for the instructions executed by a single processing unit incorporating each of the blocks or by multiple processing units incorporating one or more of the functional blocks.

Transmitter module 30 is configured to transmit streams of image data to received module 32. In the example illustrated, transmitter module 30 and receiver module 32 form a wireless real-time high-resolution image link. In the example illustrated, transmitter module 30 and receiver module 32 provide a high-speed radio link and data compression, low end-to-end delay via spatial compression and little or not data buffering.

Transmitter module 30 includes input interfaces or ports 42, 44, computer graphics decoder 46, video decoder 48, spatial compressor 50, input 51, packetizer 52 and transmitter 54. Input interface or ports 42 connects graphics source 22 to graphics decoder 46 of module 30. In one embodiment, input port 42 may comprise a wired presently available connector, such as, but not limited to, a Video Electronics Standards Association (VESA) 15-pin d-sub, Digital Video Interface (DVI), or Display Port connector. In such an embodiment, incoming computer graphics data is first decoded into an uncompressed digital computer graphics data by computer graphics decoder 46. Computer graphics decoder 46 may comprise a presently available hardware decoder, such as in AD9887A decoder device form Analog Devices of Norwood, Mass. In other embodiments, input port 42 and decoder 46 may comprise other presently available or future developed devices or may have other configurations.

Input port 44 connects video graphics source 24 to decoder 48 of module 30. In one embodiment, port 44 is a wired presently available connector, such as, but not limited to, a composite video connector, component video connector, Super-Video (S-Video) connector, Digital Video Interface (DVI) connector, High-definition Multimedia Interface (HDMI) connector or SCART connector. In such an embodiment, incoming video graphics data is first decoded into an uncompressed digital video data by computer graphics decoder 48. Video decoder 48 may comprise a presently available hardware decoder, such as an ADV7400A decoder device for an analog input from Analog Devices of Norwood, Mass. or a SiI9011 decoder device for DVI/HDMI inputs from Silicon Image of Sunnyvale, Calif. In other embodiments, input port 44 and decoder 48 may comprise other presently available or future developed devices or may have other configurations.

As indicated by broken lines, in other embodiments, transmitter module 30 may be embedded with one or both of computer graphics source 22 or video source 24. In those embodiment in which module 30 is embedded with computer graphics source 22, input port 42 may be replaced with a presently available digital interface 42+ such as a 24-bit or a 30-bit parallel data bus which provides uncompressed digital computer graphics data directly or spatial comperssor 50. In such an embodiment, computer graphics decoder 46 may be omitted.

In those embodiment in which module 30 is embedded with video source 24, input port 44 may be replaced with an interface 44′ configured to transmit a presently available digital video format, such as an ITU-R BT.601 or ITU-R BT.656 format which provides uncompressed digital video data directly to spatial compressor 50. Examples of other formats include, but are not limited to, 480i, 576i, 480p, 1080i and 1080p. In such an embodiment, video decoder 48 may be omitted. In other embodiments, interfaces 42′ and 44′ may comprise other presently available or future developed interfaces.

Spatial compressor 50 comprises a presently available or future developed device or component configured to compress the digital computer graphics data or the video data using a presently available or future developed spatial data compression algorithm. In one embodiment, spatial compressor 50 utilizes a JPEG 2000 wavelet compression algorithm as supplied by LuraTech, Inc. of San Jose, Calif. Spatial compressor 50 operates on a full frame of incoming data, one field at a time, to minimize delay to one field of video data or one frame of computer graphics data. As a result, the output of spatial compressor 50 is sequential frames of compressed computer graphics data or sequential fields of compressed video data.

Input 51 comprises one or more devices, electronic components, controllers or processing units configured to provide packetizer 52 with a filtering pattern which is to be used by packetizer 52 when filtering out frames of image data. Such filtering patterns are to be automatically applied by packetizer 52 without regard to the content or characteristics of the particular image frames being filtered out or their similarity or dissimilarity to adjacent or neighboring image frames. As a result, the filtering of image frames utilizes less processing to reduce costs and complexity. Examples of filtering patterns include, but are not limited to, removing every second frame, removing every third frame, removing every fourth frame, to removing every nth frame. A filtering pattern may also involve passing or transmitting a plurality of image frames for every frame that is filtered. For example, removing two frames out of every three frames to be sent, removing three frames out of every four frames to be sent, removing four frames out of every five frames to be sent and so on to removing n frames out of every >n frames to be sent.

In one embodiment, input 51 is configured to provide packetizer 52 with a single preselected or predefined filtering pattern. In another embodiment, input 51 is configured to provide packetizer 52 with one of a plurality of available filtering patterns, enabling the filtering pattern applied by packetizer 52 to be adjusted. Adjustment of the filtering pattern applied by packetizer 52 may be controlled by input 51. For example, input 51 may include, have access to or otherwise be associated with a memory 56 in which a plurality of available filtering patterns are stored. Input 51 may select a filtering pattern to be applied by packetizer 52 based upon the type of images being transmitted by the entire string or strings of frames (video or computer graphics), input or detected characteristic of transport mechanism 21 or user or external source filter pattern selections.

For example, computer graphics images may have content that is more static and that changes less frequently as compared to video graphics. In many applications, computer graphics correspond to content that does not change more than once every 0.25 seconds. As a result, the removal or filtering out of image frames has a lesser impact upon the perceived image quality at display 26. Thus, the filtering of image frames by packetizer 52 is well-suited for use with computer graphic images. Input 51 may be configured to enable filtering when computer graphics are being transmitted and to disable filtering when video graphics are being transmitted.

In one embodiment, input 51 may be configured to provide a filtering pattern to packetizer 52 based upon transport mechanism 21. For example, input 51 may include a user interface (keyboard, mouse, button, switch, touch screen, touch pad and the like) by which a user may enter a speed or frame rate of the transport mechanism 21, wherein input 51 selects the filtering pattern to be applied based on such user input. In another embodiment, input 51 may have a user interface for facilitating entry of the name or other characteristic of transport mechanism 21, wherein memory 56 contains stored filtering patterns to be used with particular types of transport mechanisms or transport mechanisms having the characteristics input via the user interface. In still other embodiments, input 51 may include on or more sensors or utilize one or more techniques for automatically determining the type of transport mechanism 21 being utilized, its frame rate or other characteristics.

In still other embodiments, input 51 may include a user interface enabling a person to selectively choose amongst different available filtering patterns based upon the person's perception of the quality of image being provided by display 26 or display 28 or based upon other factors.

Packetizer 52 comprises one or more devices, electronic components, controllers or processing units configured to create smaller information units out of the compressed data. Such smaller units may comprise, for example, commands, data, status information and other information, from each frame of compressed data, which is of a larger size (10,000 bytes). As will be described in more detail hereafter, prior to forming such packets, packetizer 52 analyzes the compressed data stream to identify boundaries of incoming compressed image frames and performs a filtering operation based upon a preselected filtering pattern as provided by input 51. By filtering the stream of image frames, packetizer 52 reduces the frame rate of the stream of image frames to facilitate transmission by transport mechanism 21. After such filtering, packetizer 52 places such filtered image frames into transmission packets which are transmitted to transmitter 54.

Transmitter 54 is a component, device or one or more processing units configured to transmit compressed and packetized data from module 30 to module 32. According to the example embodiment illustrated, transmitter 54 is configured to transmit the compressed and packetized data wirelessly to module 32. In one embodiment, transmitter 54 is a ultra wideband (UWB) radio transmitter. In such an embodiment, transmitter 54 provides a high-speed short-range radio link. In one embodiment, the UWB radio transmitter has a transmission range of up to, for example, but not limited to, 30 feet. The data rate of transmitter 54 may be in the range of, for example, but not limited to, 110 to 480 Mbps. In such an embodiment, transmitter 54 operates across a relatively large range of frequency bands (for example, 3.1 to 10.6 GHz) with negligible interference to existing systems using same spectrum.

Receiver module 32 receives the compressed and packetized stream of data from transmitter module 30 and manipulates or converts such data for use by either computer graphics display 26 or video display 28. Receiver module 32 includes receiver 60, input 61, depacketizer 62, spatial decompressor 64, computer graphics encoder 66, video encoder 68 and output interfaces or ports 70, 72. Receiver 60 comprises a component, device or other structure configured to receive the stream of compressed and filtered packetized data from module 30. In the particular example embodiment illustrated in which transmitter 54 is a wireless transmitter, receiver 60 is a wireless receiver. Receiver 60 and transmitter 54 form transport mechanism 21. In the example embodiment illustrated, receiver 60 is an ultra wideband radio receiver configured to cooperate with transmitter 54 to receive the stream of data. In other embodiments, receiver 60 may have other configurations depending upon the configuration of transmitter 54. In still other embodiments, where data is transmitted from module 32 receiver module 32 via electrical signals or optical signals through physical lines, transmitter 54 and receiver 60 may have other configurations or may be omitted.

Input 61 comprises one or more devices, electronic components, controllers or processing units configured to provide depacketizer 62 with a restoration pattern to be used by depacketizer 62 to reconstruct the stream of image frames so as to more closely approximate the stream prior to filtering by packetizer 52. In one embodiment, the restoration pattern corresponds to or mirrors the filtering pattern. In one embodiment, input 61 includes, has access to or is associated with a memory 76 storing restoration patterns that correspond to or mirror filtering patterns of input 51. Examples of restoration patterns include, but are not limited to, restoring or replacing every second frame, restoring every third frame, restoring every fourth frame, to restoring every n+1 frame. A restoration pattern may also involve restoring a plurality of image frames for every frame that is received. For example, restoring two frames out of every three frames, restoring three frames out of every four frames, restoring four frames out of every five frames and so on to restore n frames out of every >n frames received.

In one embodiment, the stream of received image frames includes data indicating what filtering pattern has been applied, wherein input 61 transmits a corresponding restoration pattern to depacketizer 62 based upon such data. As a result, input 61 automatically adjusts the restoration pattern being applied by depacketizer 62 as differing filtering patterns are applied by packetizer 52. In yet other embodiments, input 61 may alternatively include a user interface permitting a user to manually or otherwise enter the restoration pattern to be applied by depacketizer 62.

Depacketizer 62 is a processing unit or a portion of a processing unit configured to receive the compressed, filtered and packetized data from receiver 60 and to reconstruct the compressed packetized data into compressed frames of computer graphics data or video data. During such reconstruction, depacketizer 62 detects and resolves any errors in the incoming packet data. For example, depacketizer 62 detects and handles any packets that have been received twice and disposes of the redundant packets. In one embodiment, depacketizer 62 further detects any lost packets and replaces the loss of data with, for example, zeroes or data form a previous frame.

As will be described in more detail hereafter, depacketizer 62 reconstructs the compressed packetized data into compressed frames by replacing filtered out frames with copies of image frames that have been received by depacketizer 62. As a result, the reconstructed stream of image frames has a frame rate closer to that of the original frame rate prior to filtering by packetizer 52. In one embodiment, the reconstructed image frame rate is substantially equal to the original frame rate prior to filtering. In one embodiment, the original frame rate and the reconstructed frame rate have a frequency of 60 frames per second. Consequently, the quality of the image is enhanced. The compressed digital computer graphics data or the compressed digital video data is subsequently fed to spatial decompressor 64.

Spatial decompressor 64 comprises a presently available or future developed device, component or processing unit configured to decompress the digital computer graphics data or the video data using a presently available or future developed spatial data compression algorithm. In one embodiment, spatial compressor 64 utilizes a JPEG 2000 wavelet decompression algorithm as supplied by LuraTech, Inc. of San Jose, Calif. The stream of decompressed computer graphics data or video data are subsequently transmitted to computer graphics encoder 66 and the video encoder 68, respectively, or directly to computer graphics display 26 or video display 28.

Computer graphics encoder 66 encodes the outgoing computer graphics data into a format suitable for transmission over output port 70. In one embodiment encoder 66 is a presently available or future developed hardware encoder. Examples of a presently available computer graphics encoder include, but are not limited to, the Si1164 encoder device for a DVI output from silicon Image of Sunnyvale, Calif. or the ADV7122 encoder device for analog output from Analog Devices of Norwood, Mass. In such an embodiment, output port 70 may comprise a wired presently available or future developed connector. Examples of such a presently available connector include, but are not limited to, a VESA 15-pin d-sub, DVI, or DisplayPort connector. In other embodiments, other encoders and connectors may be utilized.

Video graphics encoder 68 encodes the outgoing computer graphics data into a format suitable for transmission over output port 72. In one embodiment encoder 68 is a presently available or future developed hardware encoder. Examples of a presently available hardware encoder include, but are not limited to, Si19190 encoder device for DVI/HDMI output from Silicon Image of Sunnyvale, Calif. or the ADV7320 encoder device for an analog output from Analog Devices of Norwood Mass. In such an embodiment, output port 72 is a wired presently available connector, such as, but not limited to, a composite video connector, a component video connector, an S-video connector, DVI connector, HDMI connector or SCART connector. In yet other embodiments, other encoders and connectors may be utilized.

As indicated by broken lines, in other embodiments, receiver module 32 may be incorporated as part of or embedded with one or both of computer graphics display 26 or video display 28. In such an embodiment, the compressed image data may be transmitted directly from spatial decompressor 64 to one or both of display 26 or display 28, enabling one or both of encoder 66 or encoder 68 to be omitted. In those embodiments in which module 32 is embedded with display 26, port 70 may be replaced with port 70′ which may comprise a presently available 24 bit or 30 bit parallel data bus. In those embodiments in which module 32 is embedded with display 28, port 72 may be replaced with port 72′ which may comprise a presently available digital interface such as an ITU-R BT.601 or IU-R BT.656 format. Examples of other formats include, but are not limited to, 480i, 576i, 480p, 720p, 1080i and 1080p. In other embodiments, ports 70′ and 72′ may have other configurations.

Although Link 20 has been illustrated as having each of the aforementioned functional blocks as provided by one or more processing units and electronic componentry, in other embodiments, Link 20 may be provided by other arrangements. Although Link 20 has been described as having a single transmitter module 30 and a single receiver module 32, in other embodiments, link 20 may alternatively include a single transmitter module 30 and multiple receiver modules 32, multiple transmitter modules 30 and a single receiver module 32, or multiple transmitter modules 30 and multiple receiver modules 32.

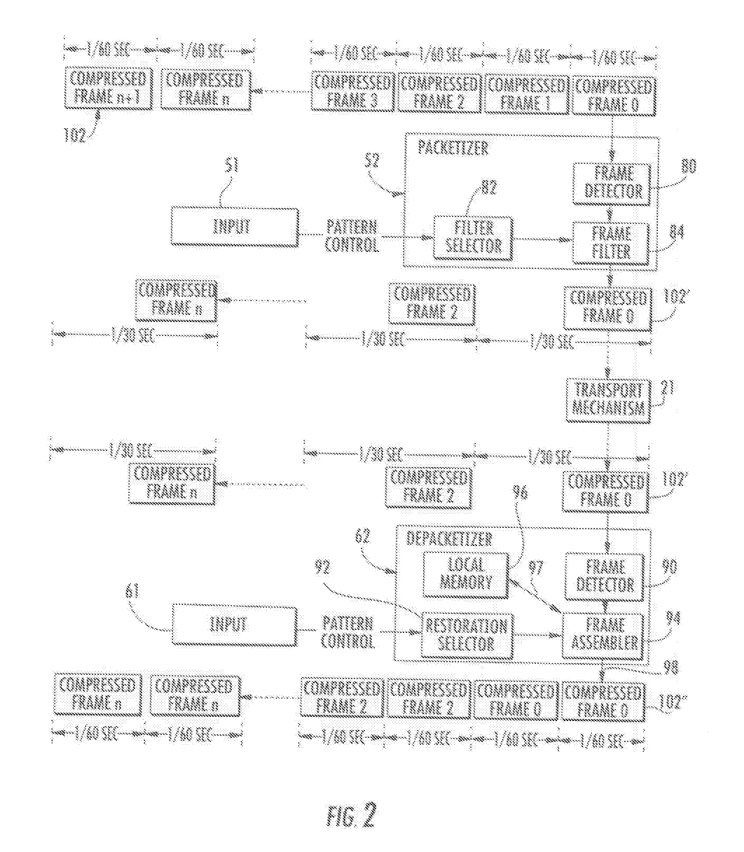

FIG. 2 schematically illustrates input 51, packetizer 52, input 61 and depacketizer 62 in more detail. FIG. 2 further schematically illustrates the filtering and restoration of a string or stream of image frames by packetizer 52 and depacketizer 62. As shown by FIG. 2, packetizer 52, sometimes referred to as packetization controller, includes frame detector 80, filter selector 82 and frame filter 84. Frame detector 80 comprises that portion of packetizer 52 configured to identify boundaries, the beginning and the end, of each frame of image data received from spatial compressor 50 (shown in FIG. 1). In one embodiment, frame detector 80 identifies such boundaries by identifying frame delimiters within the stream of compressed data received from spatial compressor 50. In other embodiments, frame detector 80 may detect the boundaries of individual image frames in other manners.

Filer selector 82 comprises that portion of packetizer 52 configured to decode pattern control signals from input 51. Based on such signals, filter selector 82 sets the filtering pattern for frame filter 84.

Frame filter 84 comprises that portion of packetizer 52 configured to receive the incoming stream of compressed frames of data whose boundaries are identified by frame detector 80. Frame filter 84 further configured to remove the data of selected compressed frames, as programmed by filter selector 82 to thereby perform a filtering function. Frame filter 84 permits or allows selected frames of data to pass through to transfer mechanism 21. In the particular example illustrated, unfiltered frames are permitted to pass through to wireless transmitter 54 (shown in FIG. 1).

As further shown by FIG. 2, depacketizer 62, sometimes referred to as a depacketization controller, includes frame detector 90, restoration selector 92, frame assembler 94 and memory 96. Frame detector 90 comprises that portion of depacketizer 62 configured to identify boundaries, the beginning and the end, of each frame of image data received from transport mechanism 21. In one embodiment, frame detector 90 identifies such boundaries by identifying frame delimiter within the stream of compressed data. In other embodiments, frame detector 90 may detect the boundaries of individual image frames in other manners.

Restoration selector 92 comprises that portion of depacketizer 62 configured to decode pattern control signals from input 61. Based on such signals, filter selector 92 sets the restoration pattern for frame assembler 94.

Frame assembler 94 comprises that portion of depacketizer 62 configured to receive the incoming stream of filtered compressed frames of data whose boundaries are identified by frame detector 90. Frame assembler 94 is further configured to at least partially restore the filtered stream of image frames based upon a restoration pattern as programmed by restoration selector 92. In the particular example embodiment illustrated, frame assembler 94 restores the stream of filtered image frames by storing an incoming compressed frame within local memory 96 while simultaneously passing the same incoming compressed image frame to decompressor 64 (shown in FIG. 1). Frame assembler 94 further passes a sufficient number of additional copies of the compressed frame from local memory 96 to decompressor 64 to at least partially restore the original frame rate which existed prior to filtering by packetizer 52.

In one embodiment, local memory 96 may comprise a presently available or future implementation of a volatile or non-volatile memory device, such as a random access memory (RAM) device. In one embodiment, memory 96 has a storage capacity at least equivalent to an expected maximum size of a single frame of compressed data. In one embodiment, memory 96 has a capacity of 256 kilobytes. In other embodiments, memory 96 may comprise other forms of persistent storage and may have other capacities.

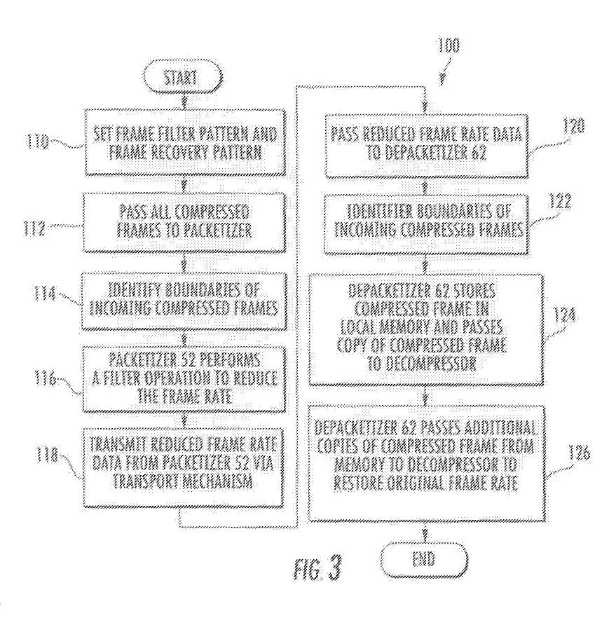

FIG. 3 is a flow diagram illustrating one example method 100 by which packetizer 52 and depacketizer 62 filter and restore a string or stream 102 of image data frames (shown in FIG. 2) before and after transmission by transport mechanism 21 (shown in FIG. 1). In the example illustrated, stream 102 includes compressed image frame 0 to image frame n+1. Stream 102 has a frame rate of 60 frames per second.

As indicated by step 110 of FIG. 3 and depicted in FIG. 2, input 51 selects a filtering pattern to be used by packetizer 52. As noted above, the filtering pattern may be selected based upon the type of images being transmitted (video or computer graphics), input or detected characteristic of transport mechanism 21 or user or external source filter pattern selections. Pattern control signals providing the selected filtering pattern are transmitted to filter selector 82 which decodes the pattern control signals and transmits such signals to frame filter 84.

Input 61 selects a restoration pattern to be used by depacketizer 62. Input 61 transmits restoration pattern control signals providing a restoration pattern to restoration selector 92 of depacketizer 62. In one embodiment, the restoration pattern corresponds to or substantially mirrors the filtering pattern provided by input 51. Restoration selector 92 decodes the pattern control signals from input 61 and transmits such signals to frame assembler 94.

As indicated by step 112 of FIG. 3 and depicted by FIG. 2, packetizer 52 receives the strong or stream 102 of compressed image frames from spatial compressor 50 (shown in FIG. 1). As indicated by step 114 of FIG. 3, frame detector 80 identifies boundaries of the incoming compressed images frames.

As indicated by step 116 in FIG. 3, frame filter 84 of packetizer 52 performs a filtering operation upon the incoming compressed image frames to reduce the frame rate. In the example illustrated in FIG. 2, frame filter 84 filters out or removes every second frame of stream 102, reducing the frame rate from 60 frames per second to 30 frames per second. For example, frame filter 84 filters or removes frames 1, 3, 5, . . . n+1 while allowing frames 0, 2, 4, . . . n to pass to transport mechanism 21, reducing the frame rate by half. In particular embodiments, this may enable transport mechanism 21 to better have a maximum transmission rate or frame rate that is less than the original frame rate of stream 102, 60 frames per second. As indicated by step 118 in FIG. 3, the filtered stream 102′ is then transmitted by transport mechanism 21 to receiver 60 (shown in FIG. 1).

As indicated by step 120 in FIG. 3 and as depicted in FIG. 2, receiver 32 passes the filtered stream 102′ to depacketizer 62. As indicated by step 122 in FIG. 3, frame detector 90 of depacketizer 62 (shown in FIG. 2) identifies the boundaries of incoming compressed image frames.

As indicated by step 124 in FIG. 3 and depicted by arrows 97 in FIG. 2, frame assembler 94 of depacketizer 62 transmits and stores a copy of a received compressed image frame in memory 96. As indicated by arrow 98 of FIG. 2, frame assembler 94 further passes or transmits either another copy or the original compressed frame to decompressor 64 (shown in FIG. 1). As indicated by step 126 of FIG. 3 and as schematically represented by arrow 98 in FIG. 2, frame assembler 94 replaces the filtered out image frames with copies of received frames. In particular, frame assembler 94 retrieves image frame data from memory 96 and passes one or more copies of the compressed frame to decompressor 64 (shown in FIG. 1) to “fill in the blanks” of stream 102′. Thus, the frame rate of stream 102′, is at least partially restored, outputting stream 102″ (shown in FIG. 2) to decompressor 64.

In the example illustrated in FIG. 2, the restoration pattern applied by frame assembler 94 mirrors the filtering pattern applied by frame filter 84. In particular, frame assembler 94 restores every second frame with a copy of a proceeding frame received by depacketizer 62. As shown by FIG. 2, frame assembler 94 stores a copy of frame 0data in memory 96 while passing frame 0 to decompressor 64. Subsequently, frame assembler 94 retrieves a copy of frame 0 data from memory 96 and passes the data to decompressor 64. In doing so, frame 0 data replaces the frame 1 data of the original string 102. In a like manner, frame assembler 94 retrieves a stored copy of the next frame, for example, frame 2 in memory 96 while passing frame 2 to decompressor 64. Subsequently, frame assembler 94 retrieves the copy of frame 2 data from memory 96 and passes the data to decompressor 64. In doing so, frame 2 data replaces frame 3 data of the original string or stream 102. Frame assembler 94 continues the process to frame n. The resulting stream 102″ of image frames consist of a frame sequent of frame 0, 0, 2, 2, . . . n, n instead of the original sequence of frames 0, 1, 2,3, . . . n, n+1. As a result, the newly formed strong or stream 102″ of compressed image frames has a frame rate of 60 frames per second. In short, instead of simply dropping every other frame which may reduce quality of the reconstructed image, depacketizer 62 fills in every other frame with alternative frame data to maintain a high quality image. In other embodiments, other filtering patterns and restoration patterns may be utilized.

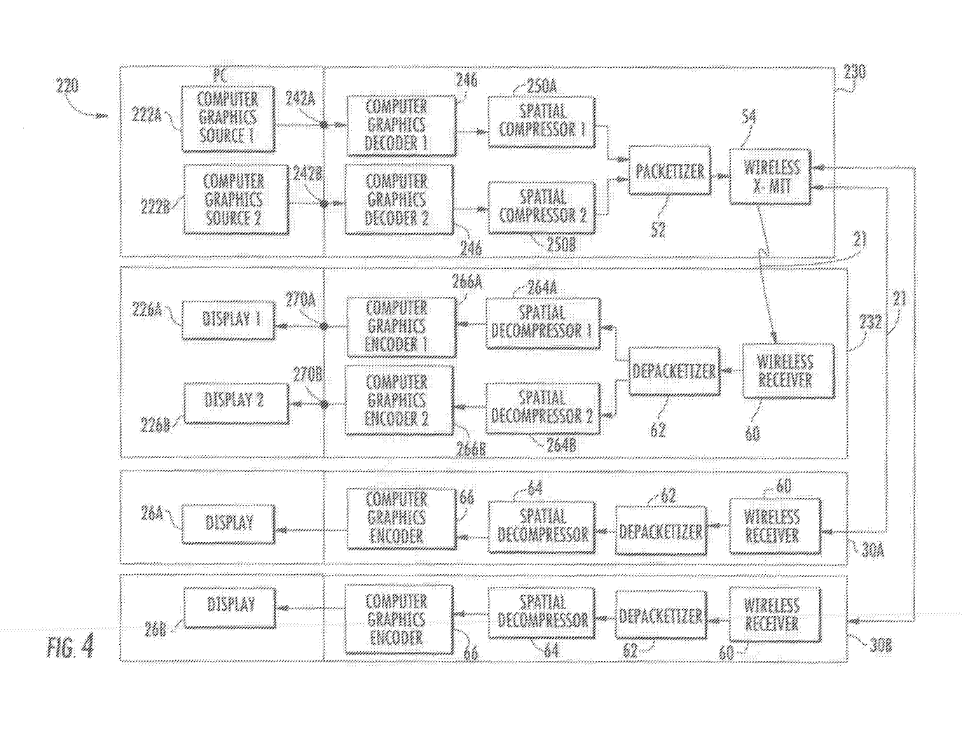

FIG. 4 schematically illustrates image transmitting and receiving system or link 220, another embodiment of link 20. Link 230 is similar to link 20 except that link 20 is configured to concurrently transmit more than one stream of image frames (and audio) for reception and display on more than one display. In the particular example illustrated, link 220 concurrently transmits image frame streams (and audio) from computer graphics sources 222A and 222B. As shown by FIG. 4, the streams of image frames are transmitted by a transmitter module 230. The streams of image frames may be transmitted to a single receiver module 232 for presentation by displays 226A and 226B or may be transmitted to more than one individual or separate receiver modules 30A and 30B for presentation by displays 26A and 26B.

Computer graphics sources 222A and 222B are substantially identical to computer graphics source 22 described above with respect to FIG. 1. Transmitter module 230 is similar to transmitter module 30 described above with respect to FIG. 1 except that module 230 includes a pair of ports 242A, 242B, a pair of computer graphics decoders 246 and a pair of spatial compressors 250A, 250B in lieu of port 42, decoder 46 and spatial compressor 50, respectively. Ports 242, decoders 246 and spatial compressors 250 are each individually substantially identical to port 44, decoder 46 and spatial compressor 50, respectively. Those remaining elements or components of transmitter module 230 that correspond to similar elements of transmitter module 30 are numbered similarly. The pairs of ports 242, decoders 246 and spatial compressors 250 facilitates the concurrent transmission of multiple image data streams. In other embodiments, module 230 may include more than two spatial compressors 250, decoders 246 and ports 242 for transmitting greater than two image frame streams.

Displays 226A and 226B are substantially identical to display 26 shown and described with respect to FIG. 1. Receiver module 232 is substantially similar to receiver module 32 (shown and described with respect to FIG. 1) except that receiver module 232 includes a pair or spatial decompressors 264A, 264B, a pair of computer graphics encoders 266A, 266 and a pair of ports 270A, 270B in lieu of decompressor 64, encoder 66 and port 70, respectively. Spatial decompressors 264, computer graphics encoders 266 and ports 270 are each individually substantially identical to decompressor 64, encoder 66 and port 70, respectively. The pairs of spatial decompressors 264, computer graphics encoders 266 and ports 270 facilitate reception and transmission of more than one stream of image frames to more than one display 226. In other embodiments, receiver module 232 may include more than two spatial decompressors 264, encoders 266 and ports 270 for transmitting image frame streams to more than two displays 226.

Displays 26A and 26B are substantially identical to display 26. Receiver modules 30A and 30B are substantially identical to receiver module 30. In other embodiments, link 220 may include more than two receiver modules 30 where transmitter module 230 is configured to transmit more than two streams of image data from more than two sources.

As noted above, link 20 facilitates transmission of a stream of image frames having a frame rate greater than the maximum frame rate of the transport mechanism 21. In a similar manner, link 220 facilitates concurrent transmission of multiple streams of image frames which collectively have a frame rate greater than a maximum frame rate of the transport mechanism 21 being utilized. By applying a filtering pattern and restoring filtered out frames according to the pattern as described above with respect to FIG. 2, packetizer 52 and the one or more depacketizer 62 of link 230 facilitate transmission of multiple streams of image frames to receiver module 232 for presentation at displays 226A, 226B or to receiver modules 30A, 30B for presentation at displays 26A, 26B despite the collective image frame rates of the streams being initially greater than the maximum frame rate of the transfer mechanism 21.

In the particular example illustrated, link 230 is describe as transmitting and presenting more than one stream of image frame data from more than one computer graphics source. In other embodiments, link 220 may alternatively be configured to transmit and present more than one stream of image frame data from more than one video source. In such an alternative embodiment, the pair of decoders 246 and ports 242 of module 230 are replaced with pairs of video decoders 48 and ports 44, respectively. In such an alternative embodiment, the pairs of computer graphics encoders 266 and ports 270 are replaced with pairs of video encoders 68 and ports 72, respectively.

Although the present disclosure has been described with reference to example embodiments, workers skilled in the art will recognize that changes may be made in form and detail without departing from the spirit and scope of the claims subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
filtering one or more streams of image frames according to a filtering pattern; and
receiving the one or more filtered stream of image frames and replacing filtered out frames with copies of received frames.

2. The method of claim 1 further comprising storing a copy of one of the received frames in a memory, wherein a filtered out frame is replaced with the copy.

3. The method of claim 1 further comprising transmitting the received frames and the copies of the received frames to a decompressor.

4. The method of claim 1, wherein the one or more streams of image frames has a first image frame rate prior to filtering and wherein the one or more streams of image frames has the first image frame rate after the filtered out frames are replaced with copies of the received frames.

5. The method of claim 1, wherein the one or more streams of images has a first image frame rate prior to filtering and wherein the method further comprises transmitting the one or more filtered streams of images via a transport mechanism having a maximum image frame rate less than the first frame rate.

6. The method of claim 5, wherein the first image frame rate is at about 60 frames per second.

7. The method of claim 1, wherein the image frames are computer graphics.

8. The method of claim 1, wherein the one or more streams of image frames prior to filtering correspond to image content that changes at a frequency of less than once every 0.25 seconds.

9. The method of claim 1, wherein at least two consecutive frames are filtered out according to the filtering system.

10. The method of claim 1, wherein a ratio of transmitted frames to filtered out frames is one according to the filtering pattern.

11. The method of claim 1, wherein a ratio of transmitted frames to filtered out frames is greater than one according to the filtering pattern.

12. The method of claim 1 further comprising storing a copy of one of the received frames immediately preceding one of the filtered frames.

13. The method of claim 1 further comprising adjusting the filtering pattern.

14. An apparatus comprising:
a packetizer configured to filter one or more streams of image frames according to a filtering patterns; and
a depacketizer configured to receive the one or more filtered streams of image frames and to replace filtered out frames with copies of received frames.

15. The apparatus of claim 14, wherein the one or more streams has a first frame rate and wherein the apparatus further comprises a transmitter having a maximum second frame rate less than the first frame rate.

16. The apparatus of claim 14 further comprising an ultra wide band radio transmitter configured to transmit filtered image frames from the packetizer to the depacketizer.

17. The apparatus of claim 14, wherein at least two consecutive frames are filtered out according to the pattern.

18. The apparatus of claim 14, wherein the packetizer is configured such that a ratio of transmitted frames to filtered out frames is greater than one according to the pattern.

19. The apparatus of claim 14, wherein the packetizer is configured to selectively adjust the filtering pattern.

20. A computer readable medium including instruction configured to:
filter one or more first streams of received image frames according to a first predefined filtering pattern; and
adjust the filtering pattern so as to filter one or more second streams of received image frames according to a second predefined filtering pattern.
